(19) United States
(12) Patent Application Publication
(10) Pub. No.: US 2020/0376822 A1
(43) Pub. Date: Dec. 3, 2020

(54) BIODEGRADABLE THREE-LAYERED FILM

(71) Applicant: BASF SE, Ludwigshafen am Rhein (DE)

(72) Inventors: Robert LOOS, Ludwigshafen am Rhein (DE); Joerg AUFFERMANN, Ludwigshafen am Rhein (DE); Norbert EFFEN, Ludwigshafen am Rhein (DE); Nora SCHLUTT, Ludwigshafen am Rhein (DE); Carsten SINKEL, Ludwigshafen am Rhein (DE); Jerome LOHMANN, Ludwigshafen am Rhein (DE); Gabriel SKUPIN, Ludwigshafen am Rhein (DE); Andreas KUENKEL, Ludwigshafen am Rhein (DE)

(21) Appl. No.: 16/622,322

(22) PCT Filed: Apr. 5, 2018
(86) PCT No.: PCT/EP2018/058735

§ 371 Date: Dec. 13, 2019

(30) Foreign Application Priority Data
Jun. 19, 2017 (EP) 17176626.4

(51) Int. Cl. B32B 27/36; B32B 27/08; B32B 27/20; B32B 27/22

(52) U.S. Cl. CPC B32B 27/365; B32B 27/08; B32B 27/20; B32B 27/22; B32B 2250/03; B32B 2250/244; B32B 2367/00; B32B 2270/00; B32B 2307/412; B32B 2307/5825; B32B 2307/7163; B32B 2307/724; B32B 2250/40

(57) ABSTRACT

The invention relates to a biodegradable three-layer polyester film of 8 to 20 μm in thickness having a layer construction NB/C or preferably A/B/A, wherein the two outer layers (A) or (A, C) are composed of:
Ai) 55% to 99.99% by weight based on the polyester mixture of the outer layers of a polyester selected from the group consisting of: polybutylene sebacate-co-terephthalate, polybutylene sebacate-co-adipate-co-terephthalate, polybutylene sebacate-co-succinate-co-terephthalate or mixtures thereof or a mixture of polybutylene sebacate-co-terephthalate and polybutylene adipate-co-terephthalate;
Aii) 0.01% to 5% by weight based on the polyester mixture of the outer layers of at least one additive selected from the group consisting of: a wax, a plasticizer, a nucleating agent, antifogging agents, fillers and an antiblocking agent; and
Aiii) 0% to 44.99% by weight based on the polyester mixture of the outer layers of a further biodegradable polymer selected from the group consisting of: polylactic acid (PLA), polycaprolactone (PCL), polyhydroxyalkanoate, polypropylene carbonate (PPC) or polyester produced from aliphatic dicarboxylic acids and an aliphatic dihydroxy compound;
and the middle layer B is composed of:
Bai) 40% to 75% by weight based on the mixture of the middle layer of a biodegradable aliphatic-aromatic polyester;
Baii) 25% to 40% by weight based on the mixture of the middle layer of starch having a plasticizer content of 0% to 5% by weight based on the total weight of the component Baii); and
Baiii) 0% to 20% by weight based on the mixture of the middle layer of a further biodegradable polymer selected from the group consisting of: polylactic acid (PLA), polycaprolactone (PCL), polyhydroxyalkanoate, polypropylene carbonate (PPC) or polyester produced from aliphatic dicarboxylic acids and an aliphatic dihydroxy compound;
or
Bbi) 25% to 70% by weight based on the mixture of the middle layer of a biodegradable aliphatic-aromatic polyester;
Bbii) 30% to 55% by weight based on the mixture of the middle layer of starch having a plasticizer content of 5% to 35% by weight based on the total weight of the component Bbii); and
Bbiii) 0% to 20% by weight based on the mixture of the middle layer of a further biodegradable polymer selected from the group consisting of: polylactic acid (PLA), polycaprolactone (PCL), polyhydroxyalkanoate, polypropylene carbonate (PPC) or polyester produced from aliphatic dicarboxylic acids and an aliphatic dihydroxy compound.

The invention relates to a biodegradable three-layer polyester film of 8 to 20 μm in thickness having a layer construction A/B/C or preferably A/B/A, wherein the two outer layers (A) or (A, C) are composed of:
Ai) 55% to 99.99% by weight based on the polyester mixture of the outer layers of a polyester selected from the group consisting of: polybutylene sebacate-co-terephthalate, polybutylene sebacate-co-adipate-co-terephthalate, polybutylene sebacate-co-succinate-co-terephthalate or mixtures thereof or a mixture of polybutylene sebacate-co-terephthalate and polybutylene adipate-co-terephthalate;
Aii) 0.01% to 5% by weight based on the polyester mixture of the outer layers of at least one additive selected from the group consisting of: a wax, a plasticizer, a nucleating agent, antifogging agents, fillers and an antiblocking agent; and
Aiii) 0% to 44.99% by weight based on the polyester mixture of the outer layers of a further biodegradable polymer selected from the group consisting of: polylactic acid (PLA), polycaprolactone (PCL), polyhydroxyalkanoate, polypropylene carbonate (PPC) or polyester produced from aliphatic dicarboxylic acids and an aliphatic dihydroxy compound;
and the middle layer B is composed of:
Bai) 40% to 75% by weight based on the mixture of the middle layer of a biodegradable aliphatic-aromatic polyester;
Baii) 25% to 40% by weight based on the mixture of the middle layer of starch having a plasticizer content of 0% to 5% by weight based on the total weight of the component Baii); and
Baiii) 0% to 20% by weight based on the mixture of the middle layer of a further biodegradable polymer selected from the group consisting of: polylactic acid (PLA), polycaprolactone (PCL), polyhydroxyalkanoate, polypropylene carbonate (PPC) or polyester produced from aliphatic dicarboxylic acids and an aliphatic dihydroxy compound;
or
Bbi) 25% to 70% by weight based on the mixture of the middle layer of a biodegradable aliphatic-aromatic polyester;
Bbii) 30% to 55% by weight based on the mixture of the middle layer of starch having a plasticizer content of 5% to 35% by weight based on the total weight of the component Bbii); and
Bbiii) 0% to 20% by weight based on the mixture of the middle layer of a further biodegradable polymer selected from the group consisting of: polylactic acid (PLA), polycaprolactone (PCL), polyhydroxyalkanoate, polypropylene carbonate (PPC) or polyester produced from aliphatic dicarboxylic acids and an aliphatic dihydroxy compound.

The invention further relates to three-layer polyester films having the abovementioned composition and layer thickness which have an oxygen permeability according to ASTM D3985-05:2010 between 5500 and 18 000 ml/m²/day and preferably of 6000 to 12 000 ml/m²/day of a water vapor permeability measured according to ASTM F1249:2013 of 200 to 1000 g/m²/day, preferably of 400 to 800 g/m²/day.

Foodstuffs such as fruit and vegetables are packaged in plastic films for hygiene reasons and also for reasons of shelflife. High demands in respect of tear propagation strength and transparency are placed on the films. Most perishable foodstuffs are packaged in non-biodegradable plastic films such as polypropylene, polyethylene and polyvinyl chloride films. This has the disadvantage that already perished product must be incinerated including its packaging which is not ecologically sensible even merely due to the high water content of the foodstuff. Among the very thin (8 to 20 μm) biodegradable films, starch-containing films in particular have achieved market penetration. They generally have a high tear propagation strength but are unconvincing in respect of transparency. For example the use of fully automatic checkouts requires a high transparency of packaging films.

The three-layer films described at the outset which exhibit not only good tear propagation strength but also a high transparency especially in the transverse direction have now surprisingly been found.

The shelflife of fresh fruit and vegetables has a very strong dependency on the storage and transport thereof. In particular the type of packaging thereof also has a substantial influence on shelflife. Most perishable foodstuffs require packaging having a high oxygen and water vapor permeability.

An excessively low oxygen permeability of the film results in an excess of oxygen within the packaging and thus in accelerated ripening of the packaged foodstuff. This reduces the shelflife of the packaged foodstuff.

An excessively low water vapor permeability of the film results in condensation of water inside the packaging and can thus promote rotting and mold formation. This also reduces the shelflife of the packaged foodstuff.

It was accordingly a further objective of the present invention to provide for certain foodstuffs, such as carrots, mushrooms, Brussels sprouts and lettuce, an optimized packaging made of a biodegradable material which guarantees not only the required tear propagation strength and transparency but also a prolonged shelflife for the respective foodstuff.

The invention is described more particularly hereinbelow:

The abovementioned biodegradable three-layer polyester film of 8 to 20 μm in thickness having a layer construction A/B/C or preferably A/B/A, wherein the two outer layers (A) or (A, C) are composed of:
Ai) 55 to 99.99% by weight, preferably 70% to 99.9% by weight and especially preferably 90% to 99.9% by weight based on the polyester mixture of the outer layers of a polyester selected from the group consisting of: polybutylene sebacate-co-terephthalate, polybutylene sebacate-co-adipate-co-terephthalate, polybutylene sebacate-co-succinate-co-terephthalate or mixtures thereof or a mixture of polybutylene sebacate-co-terephthalate and polybutylene adipate-co-terephthalate;
Aii) 0.01% to 5% by weight, preferably 0.1% to 5% by weight, based on the polyester mixture of the outer layers of at least one additive selected from the group consisting of: a wax, a plasticizer, a nucleating agent, antifogging agents, fillers and an antiblocking agent; and
Aiii) 0 to 44.99% by weight, preferably 1% to 29.9% by weight and especially preferably 0% to 9.9% by weight based on the polyester mixture of the outer layers of a further biodegradable polymer selected from the group consisting of: polylactic acid (PLA), polycaprolactone (PCL), polyhydroxyalkanoate, polypropylene carbonate (PPC) or polyester produced from aliphatic dicarboxylic acids and an aliphatic dihydroxy compound;
and the middle layer B is composed of:
Bai) 40% to 75% by weight, preferably 50% to 75% by weight, based on the mixture of the middle layer of a biodegradable aliphatic-aromatic polyester;
Baii) 25% to 40% by weight based on the mixture of the middle layer of starch having a plasticizer content of 0% to 5% by weight based on the total weight of the component Baii); and
Baiii) 0% to 20% by weight, preferably 0% to 10% by weight, based on the mixture of the middle layer of a further biodegradable polymer selected from the group consisting of: polylactic acid (PLA), polycaprolactone (PCL), polyhydroxyalkanoate, polypropylene carbonate (PPC) or polyester produced from aliphatic dicarboxylic acids and an aliphatic dihydroxy compound;
or
Bbi) 25% to 70% by weight, preferably 35% to 70% by weight, based on the mixture of the middle layer of a biodegradable aliphatic-aromatic polyester;
Bbii) 30% to 55% by weight based on the mixture of the middle layer of starch having a plasticizer content of 5% to 35% by weight based on the total weight of the component Bbii); and
Bbiii) 0% to 20% by weight, preferably 0% to 10% by weight, based on the mixture of the middle layer of a further biodegradable polymer selected from the group consisting of: polylactic acid (PLA), polycaprolactone (PCL), polyhydroxyalkanoate, polypropylene carbonate (PPC) or polyester produced from aliphatic dicarboxylic acids and an aliphatic dihydroxy compound are in accordance with the invention.

Especially preferred moreover are three-layer films of 8 to 20 μm in thickness having a layer construction A/B/C or preferably A/B/A having an oxygen permeability measured according to ASTM D3985-05:2010 between 5500 and 18 000, preferably of 6000 to 12 000 and especially preferably of 6500 to 9000 ml/m²/day, wherein the two outer layers (A) or (A, C) and the middle layer (B) have the abovementioned composition.

The outer layers (A) or (A, C) generally make up 5% to 30%, preferably 8% to 25% and especially preferably 8% to 20% of the total layer of the three-layer film.

The abovementioned semiaromatic or aliphatic-aromatic polyesters are contemplated in principle for the production of the biodegradable polyesters or polyester mixtures in the outer layers (A) and optionally (C) and in the middle layer (B). Common to these polyesters is that they are biodegradable according to DIN EN 13432.

According to the invention the term biodegradable aliphatic-aromatic polyesters (components Ai) is to be understood as also meaning polyester derivatives comprising up to 10% by weight of polyether esters, polyester amides or polyether ester amides and polyester urethanes. The suitable semiaromatic polyesters include linear, non-chain-extended polyesters (WO 92/09654). Preference is given to chain-extended and/or branched semiaromatic polyesters. The latter are known from the documents WO 96/15173 to 15176, 21689 to 21692, 25446, 25448 or WO 98/12242 that are recited at the outset and hereby explicitly incorporated by reference. Mixtures of different semiaromatic polyesters are likewise contemplated. Interesting recent developments are based on renewable raw materials (see WO-A 2006/097353, WO-A 2006/097354 and also WO-A 2010/034710). The term semiaromatic polyesters is to be understood as meaning especially products such as Ecoflex® (BASF SE) and Origo-Bi® (Novamont).

Particularly preferred aliphatic-aromatic polyesters include polyesters comprising as essential components:
A) an acid component composed of
   a1) 30 to 99 mol %, preferably 40 to 60 mol % of a sebacic acid, or mixtures or ester-forming derivatives or mixtures thereof, or mixtures of sebacic acid with adipic acid or succinic acid;
   a2) 1 to 70 mol %, preferably 40 to 60 mol %, of a terephthalic acid or the ester-forming derivative thereof or mixtures thereof and
B) 98.5 to 100 mol % based on the acid component A of a diol component 1,4-butanediol; and
C) 0 to 1.5 mol %, preferably 0.01 to 0.5 mol %, based on the acid component A of a component selected from
   c1) a compound having at least three groups capable of ester formation,
   c2) a diisocyanate or polyisocyanate,
   c3) a diepoxide or polyepoxide,
   or mixtures of c1) to c3).

According to the invention, succinic acid, adipic acid and sebacic acid or their respective ester-forming derivatives or mixtures thereof are employed. Succinic acid and sebacic acid further have the advantage that they are obtainable from renewable raw materials. It is particularly preferable to employ adipic acid or sebacic acid or their respective ester-forming derivatives or mixtures thereof.

The following semiaromatic polyesters are in accordance with the invention: polybutylene sebacate-co-terephthalate (PBSeT) or polybutylene sebacate-co-adipate-co-terephthalate (PBSeAT) or polybutylene sebacate-co-succinate-co-terephthalate (PBSeST) or mixtures thereof or a mixture of polybutylene sebacate-co-terephthalate (PBSeT) and polybutylene adipate-co-terephthalate (PBAT).

For the copolymers polybutylene sebacate-co-adipate-co-terephthalate or polybutylene sebacate-co-succinate-co-terephthalate of the outer layers it has proven advantageous for a high transparency and oxygen permeability of the films when the ratio of the aliphatic dicarboxylic acids:sebacic acid to adipic acid or succinic acid is 20:1 to 1:2, preferably 15:1 to 1:1. Also for the mixtures of polybutylene sebacate-co-terephthalate and polybutylene adipate-co-terephthalate it has proven advantageous for a high transparency and oxygen permeability when the ratio of the semiaromatic polyesters PBSeT and PBAT is 20:1 to 1:2, preferably 15:1 to 1:1. For the same reason polybutylene sebacate-co-teraphthalate is particularly preferred as the sole aliphatic-aromatic polyester component in the outer layers.

The preferred semiaromatic polyesters are characterized by a molecular weight (Mₙ) in the range from 1000 to 100 000, in particular in the range from 9000 to 75 000 g/mol, preferably in the range from 10 000 to 50 000 g/mol and a melting point in the range from 60° C. to 170° C., preferably in the range from 80° C. to 150° C.

The advantages of addition of a component Aii in the outer layers are described below.

It is generally wax that is added in component Aii. Wax is to be understood as meaning for example C₁₈-C₂₄ carboxamides such as stearamide, erucamide or behenamide or beeswax or beeswax esters. The addition of waxes in 0.01% to 1% by weight and particularly preferably 0.05% to 1% by weight based on the polymer mixture makes it possible to adjust the water vapor permeability of the polyester film measured according to ASTM F1249:2013 to values below 300 g/m²/day. An increase in the layer thickness of the polyester film also results in a reduction in its water vapor permeability.

Addition of a plasticizer (for example Citrofol) makes it possible to improve the resilience of the films. The films return to their original shape after mechanical stress, for example a finger impression. Antifogging agents (for example ethoxylated sorbitan esters such as for example At-mer) are generally surfactants which ensure that even at high atmospheric humidity no disturbing water droplets are formed on the film surface. Merely a water film, which does not disturb the optics of the film, is formed.

Antiblocking agents (for example calcium carbonate) are processing aids which prevent the blocking of two plastics films and thus make the films separable.

The inventive outer layer of the polyester film may comprise further additives known to those skilled in the art. Examples include the additives customary in the plastics industry such as stabilizers; antistats, UV absorbers; compatibilizers such as an epoxy-containing copolymer based on styrene, acrylic esters and/or methacrylic esters or dyes. These additives are generally employed in concentrations of 0% to 2% by weight, in particular 0.1% to 1% by weight, based on the polymer mixture according to the invention

It is further possible to add to the outer layer according to the invention up to 44.99% by weight, preferably 1% to 29.9% by weight and especially preferably 0% to 10% by weight based on the total weight of the outer layers further biodegradable polymers (component Aiii) selected from the group consisting of: polylactic acid (PLA), polycaprolactone (PCL), polypropylene carbonate, polyhydroxyalkanoate or polyesters produced from aliphatic dicarboxylic acids and an aliphatic dihydroxy compound.

Polylactic acid is preferably added in an amount of 1% to 44.99% by weight, preferably 1% to 35% by weight, particularly preferably 4% to 18% by weight, based on the total weight of the outer layer.

It is preferable to employ PLA having the following profile of properties:
a melt volume rate (MVR) according to EN ISO 1133 (190° C., 2.16 kg weight) of 0.5 to 30, in particular 2 to 40, cm³/10 min)
a melting point below 240° C.;
a glass transition temperature (Tg) greater than 55° C.
a water content of less than 1000 ppm
a residual monomer content (lactide) of less than 0.3%.
a molecular weight of greater than 80 000 Dalton.

Preferred polylactic acids are for example Ingeo® 8052D, 6201D, 6202D, 6251D, 3051D, 3052D and in particular Ingeo® 4020D, 4032D, 4043D or 4044D (polylactic acid from NatureWorks) or Luminy® L175, L130, L105 or LX175 from Corbion.

Addition of PLA in the claimed quantity range makes it possible to further markedly improve the properties of the polyester film (penetration resistance and tear propagation strength) produced from the polymer mixture. It is also possible to employ mixtures of low-viscosity and relatively high-viscosity PLA.

Aliphatic polyesters may preferably also be employed in amounts of 5% to 45% by weight based on the total weight of the outer layer.

The term aliphatic polyesters is to be understood as also meaning polyesters of aliphatic diols and aliphatic dicarboxylic acids such as polybutylene succinate (PBS), polybutylene adipate (PBA), polybutylene succinate adipate (PBSA), polybutylene succinate sebacate (PBSSe), polybutylene sebacate (PBSe) or corresponding polyesters having a polyesteramide or polyester urethane partial structure. The aliphatic polyesters are marketed by Mitsubishi under the name BIOPBS for example. More recent developments are described in WO-A 2010/034711.

Similar effects are observed when 1% to 30% by weight or preferably 4% to 20% by weight based on the total weight of the outer layer of a polyhydroxyalkanoate is added to the polyester films.

The term polyhydroxyalkanoates is primarily to be understood as meaning poly-4-hydroxybutyrates and poly-3-hydroxybutyrates and copolyesters of the abovementioned polyhydroxybutyrates with 3-hydroxyvalerate, 3-hydroxyhexanoate and/or 3-hydroxyoctanoate.

Poly(3-hydroxybutyrates) are marketed for example by PHB Industrial under the brand name Biocycle® and by Tianan under the name Enmat®.

Poly-3-hydroxybutyrate-co-4-hydroxybutyrates are known from Metabolix in particular. They are sold under the trade name Mirel®.

Poly-3-hydroxybutyrate-co-3-hydroxyhexanoates are known from Kaneka. Poly-3-hydroxybutyrate-co-3-hydroxyhexanoates generally have a 3-hydroxyhexanoate proportion of 1 to 20 and preferably of 3 to 15 mol % based on the polyhydroxyalkanoate. The polyhydroxyalkanoates generally have a molecular weight Mw of 100 000 to 1 000 000 and preferably of 300 000 to 600 000.

As the middle layer B the abovementioned composition has and comprises thermoplastic starch, wherein the plasticizer content may vary.

The thickness of the middle layer is generally 40% to 90%, preferably 50% to 84% and especially preferably 60% to 84% of the total layer of the three-layer film.

The term aliphatic-aromatic polyesters is to be understood as meaning the polyesters, polyester mixtures or copolyesters discussed for the outer layer. Preferably employed in the middle layer are the aliphatic-aromatic polyesters polybutylene sebacate-co-terephthalate or polybutylene adipate-co-terephthalate or mixtures of these two polyesters.

For the starch a distinction is made between native and thermoplastic starch. Native starch is in the form of highly crystalline grains (granules) whose melting point is higher than their decomposition temperature. The not inconsiderable proportion of relatively large granules of more than 10 μm in diameter in for example maize, wheat or potato starch makes production of high-quality thin films impossible. It has therefore proven advantageous in the production of biodegradable polymer blends to initially fully thermoplasticize the starch by breaking up its granular and crystalline structure.

The processes for achieving this may be roughly distinguished into 2 types:
1) Plasticization of native starch may be carried out using suitable polar plasticizers (for example glycerol, sorbitol, oligoglycerol or mixtures thereof) in an extruder the use of temperature and shear stress, wherein plasticizer proportions between 20% to 35% (based on anhydrous starch) are typically employed. The water present in the starch is generally removed during the extrusion procedure (see for example EP-A 539 541, EPA 575 349, EP-A 652 910). The thus obtained fully plasticized starch may be either a) isolated and in a second separate extrusion step mixed with the biodegradable polymer or b) the plasticizing of the starch and the mixing with the biodegradable polymer is carried out in a single extrusion step.
An example of a) is the commercially available thermoplastic starch from Agrana (Amitroplast®8940) while process b) is performed by Novamont (MaterBi®).
2) It is also possible to utilize the water bound internally in the native starch for thermo-plasticizing the starch, wherein an extrusion process is likewise used to introduce temperature and shear energy in a twin-screw extruder for example, without the need to add external plasticizers. This process from Biotec (BioPlast®) is described especially for potato starch which has a high native water content of about 18-20% in WO 2002/16468 or U.S. Pat. No. 7,214,414 for example.

The middle layer comprising thermoplastic starch promotes good degradability in the ground as well as good mechanical properties such as in particular a high tear propagation strength of the three-layer film.

The middle layer may also comprise up to 20% by weight, preferably up to 10% by weight, based on the total weight of the middle layer of a further biodegradable polymer selected from the group consisting of polylactic acid (PLA), polycaprolactone (PCL), polyhydroxyalkanoate, polypropylene carbonate (PPC) or polyester produced from aliphatic dicarboxylic acids and an aliphatic dihydroxy compound. The biodegradable polymers have the abovementioned preferred structural configurations.

The three-layer polyester film may further comprise for example in the middle layer inorganic fillers such as carbon black, graphite, calcium carbonate, talc, silicate, kaolin, wollastonite, mica, montmorillonite, muscovite or iron oxide. In transparent films it is preferable to employ finely divided fillers in concentrations of less than 10% by weight and preferably less than 5% by weight based on the total weight of the three-layer film.

It is advantageous to the production of the three-layer films according to the invention when the melt volume rate (MVR) of the middle layer and that of the outer layers measured according to EN ISO 1133 (190° C., 5 kg weight) differ from one another by not more than 5 cm³/10 min at a water content of the middle layer of less than 2000 ppm.

It is especially preferable when the MVR of the middle layer measured at a water content of less than 2000 ppm is the same as or preferably 0.5 to 3 cm³/10 min lower than the MVR of the outer layers in each case measured according to EN ISO 1133 (190° C., 5 kg weight). The MVR of the middle layer is preferably in the range from 0.5 to 11 cm³/10 min and especially preferably 2 to 8 cm³/10 min and that of the outer layers is preferably in the range from 2.5 to 11 cm³/10 min and preferably in the range from 3 to 10 cm³/10 min.

The polyester films according to the invention also comprise multilayer films having more than three layers which comprise the outer layers and the middle layer according to the invention.

Production of the three-layer films is carried out in particular using the process of coextrusion. It has proven advantageous therein for the outer layers of the three-layer film to comprise no volatile plasticizers such as glycerol or sorbitol. In the production and processing of the three-layer polyester film the emergence of these plasticizers may be entirely or at least virtually prevented, which is advantageous for reasons of occupational health. Furthermore, the abovementioned configuration of the melt volume rates (MVR) for the outer layers and the middle layer results in a practicable process. In the production of the coextruded films the neck-in of the multilayer films is particularly low when the MVR of the middle layer measured at a water content of less than 2000 ppm is the same as or preferably 0.5 to 3 cm³/10 min lower than the MVR of the outer layers in each case measured according to EN ISO 1133 (190° C., 5 kg weight). The coextrusion process is especially practicably performable when the MVR of the middle layer is in the range from 0.5 to 11 cm³/10 min and especially preferably 2 to 8 cm³/10 min and that of the outer layers is preferably in the range from 2.5 to 11 cm³/10 min and preferably in the range from 3 to 10 cm³/10 min.

The polyester films according to the invention have a surprisingly high transparency. In the experiments which follow the three-layer polyester film even has a higher transparency than the monolayer films that comprised no starch. Three-layer films having the outer layers according to the invention moreover had a higher transparency than comparable three-layer films having a polybutylene adipate-co-terephthalate outer layer. The haze according to ASTM D1003: 2013 is preferably in the range from 35% to 60% and especially preferably in the range from 40% to 50%.

The polyester films according to the invention further have a high tear propagation strength in the transverse direction which is attributable in particular to the starch-comprising middle layer. In the Elmendorftest according to EN OSO 6383-2:2004 tear propagation strengths of generally greater than 600 Nm in the transverse direction are achieved.

On account of their high oxygen permeability and their high water vapor permeability compared to non-degradable polypropylene or polyethylene films the polyester films according to the invention show excellent suitability for packaging of fruit and vegetables, wherein at 5° C. the fruit and vegetables exhibit a carbon dioxide emission of more than 5 ml CO₂/kg·h and a water emission of more than 200 mg/kg/sec/Mpa.

The polyester films according to the invention are particularly suitable for packaging of foodstuffs such as carrots, mushrooms, Brussels sprouts or lettuce and thus play a decisive role in prolonging the shelflife of these foodstuffs. The use of these polyester films of 8 to 20 μm and preferably 8 to 15 μm in thickness with the aforementioned composition is thus likewise preferred for packaging of carrots, mushrooms, Brussels sprouts or lettuce.

The term packaging materials in the context of the invention is to be understood as also including composite materials made of paper/cardboard or a plastics film made of materials other than those recited hereinabove and covered with the inventive polyester film of 8 to 20 μm and preferably 8 to 15 μm in thickness.

### EXAMPLES

Materials Employed:
A-1: Polymer mixture composed of 87% by weight of Ecoflex® FS Blend C2200 (polybutylene sebacate-co-terephthalate from BASF SE), 9% by weight of Ingeo® 4044D (polylactic acid from NatureWorks), 3.6% by weight of chalk, 0.3% by weight of fatty acid amide, 0.1% by weight of Joncryl ADR 4368 (glycidyl acrylate from BASF SE)
A-2: Polymer mixture composed of 88.4% by weight of Ecoflex® F Blend C1200 (polybutylene adipate-co-terephthalate from BASF SE), 9% by weight of Ingeo® 4044D, 2.4% by weight of chalk, 0.1% by weight of fatty acid amide, 0.1% by weight of Joncryl ADR 4368
B-1 Polymer mixture composed of 65% by weight Ecoflex® F Blend C1200 and 35% by weight of Amitroplast 8940 (thermoplasticized starch from Agrana)

TABLE 1
Film construction

| | V-1 | V-2 | 3 | 4 | V-3 | V-4 |
|---|---|---|---|---|---|---|
| Layer construction | A-1 | A-1 | A-1/B-1/A-1 | A-1/B-1/A-1 | A-2 | B-1 |
| | | | 10/80/10 | 10/80/10 | | |
| Thickness [μm] | 20 | 12 | 20 | 12 | 12 | 12 |
| Transparency [%] | 92.2 | 93.2 | 92.8 | 93.5 | 93.1 | 92.9 |
| Haze [%] | 57.5 | 49.4 | 50.3 | 45.1 | 62.6 | 97.6 |
| Clarity [%] | 43.5 | 48.9 | 42.8 | 48.4 | 51.5 | 12.7 |

In the present application the oxygen permeability of the polyester film always relates to the method of measurement ASTM D3985-05:2010 measured at 23° C. and dried oxygen.

In the present application the water vapor permeability of the polyester film always relates to the method of measurement ASTM F1249:2013 measured at 23° C. and 100% rH.

Tear propagation strength was determined by an Elmendorf test according to EN ISO 6383-2:2004 using an instrument from Protear on specimens with constant radius (tear length 43 mm).

The elastic modulus and the results of the tensile test were determined according to ISO 527-3:2003-07 on films produced by blown film processes and having a thickness of about 12 μm.

Determination of total transmission, haze and clarity was measured according to ASTM D1003: 2013. The measurements were performed with a haze-gard plus transparency measuring apparatus from BYK-Gardner GmbH which performs measurements according to ASTM D1003.

In the context of the present invention, the feature “biodegradable” is satisfied for a substance or a substance mixture if this substance or the substance mixture shows a percentage biodegradation according to DIN EN 13432 of at least 90%.

Biodegradability generally results in the polyester (mixtures) decomposing in an appropriate and verifiable timeframe. Degradation can take place enzymatically, hydrolytically, oxidatively, and/or by the action of electromagnetic radiation, for example UV radiation, and is usually predominantly effected by the action of microorganisms such as bacteria, yeasts, fungi, and algae. Biodegradability is quantifiable, for example, by mixing polyesters with compost and storing them for a certain time. For example according to DIN EN 13432 (which refers to ISO 14855) CO₂-free air is passed through matured compost during composting and said compost is subjected to a defined temperature program. Biodegradability is here defined via the ratio of the net CO₂ release from the sample (after subtraction of the CO₂ released by the compost without a sample) to the maximum CO₂ release from the sample (calculated from the carbon content of the sample) as a percentage degree of biodegradation. Biodegradable polyester (mixtures) generally show clear signs of degradation such as fungus growth and tear and hole formation after just a few days of composting.

Other methods for determining biodegradability are described for example in ASTM D 5338 and ASTM D 6400-4.

The biodegradable polyester films mentioned at the outset are suitable for production of blown films, chill roll films with or without alignment in a further process step, with or without metallization or SiOx coating.

The inventive polyester films comprising the components i) and iia to iid are especially suitable for blown films and stretch wrapping films. Possible applications here include bottom gusset bags, side seam bags, grip hole carrier bags, shrink labels or vest type carrier bags, inliners, heavy-duty bags, freezer bags, composting bags, film bags, peelable closure film—transparent or opaque—weldable closure film—transparent or opaque—, keep-fresh film (stretch wrapping film), peelable lidding films.

1. A biodegradable three-layer polyester film of 8 to 20 μm in thickness having a layer construction A/B/C or A/B/A, wherein the two outer layers (A) or (A, C) are composed of:
Ai) 55% to 99.99% by weight based on the polyester mixture of the outer layers of a polyester selected from the group consisting of: polybutylene sebacate-co-terephthalate, polybutylene sebacate-co-adipate-co-terephthalate, polybutylene sebacate-co-succinate-co-terephthalate or mixtures thereof or a mixture of polybutylene sebacate-co-terephthalate and polybutylene adipate-co-terephthalate;
Aii) 0.01% to 5% by weight based on the polyester mixture of the outer layers of at least one additive selected from the group consisting of: a wax, a plasticizer, a nucleating agent, antifogging agents, fillers and an antiblocking agent; and
Aiii) 0% to 44.99% by weight based on the polyester mixture of the outer layers of a further biodegradable polymer selected from the group consisting of: polylactic acid (PLA), polycaprolactone (PCL), polyhydroxyalkanoate, polypropylene carbonate (PPC) or polyester produced from aliphatic dicarboxylic acids and an aliphatic dihydroxy compound;
and the middle layer B is composed of:
Bai) 40% to 75% by weight based on the mixture of the middle layer of a biodegradable aliphatic-aromatic polyester;
Baii) 25% to 40% by weight based on the mixture of the middle layer of starch having a plasticizer content of 0% to 5% by weight based on the total weight of the component Baii); and
Baiii) 0% to 20% by weight based on the mixture of the middle layer of a further biodegradable polymer selected from the group consisting of: polylactic acid (PLA), polycaprolactone (PCL), polyhydroxyalkanoate, polypropylene carbonate (PPC) or polyester produced from aliphatic dicarboxylic acids and an aliphatic dihydroxy compound;
or
Bbi) 25% to 70% by weight based on the mixture of the middle layer of a biodegradable aliphatic-aromatic polyester;
Bbii) 30% to 55% by weight based on the mixture of the middle layer of starch having a plasticizer content of 5% to 35% by weight based on the total weight of the component Bbii); and
Bbiii) 0% to 20% by weight based on the mixture of the middle layer of a further biodegradable polymer selected from the group consisting of polylactic acid (PLA), polycaprolactone (PCL), polyhydroxyalkanoate, polypropylene carbonate (PPC) or polyester produced from aliphatic dicarboxylic acids and an aliphatic dihydroxy compound.

2. The film according to claim 1, wherein the polyester Ai of the outer layers is polybutylene sebacate-co-terephthalate.

3. The film according to claim 1, wherein the aliphatic-aromatic polyester of the middle layer is polybutylene sebacate-co-terephthalate and/or polybutylene adipate-co-terephthalate.

4. The film according to claim 1, wherein the MVR of the middle layer measured at a water content of less than 2000 ppm is between 0.5 to 3 cm³/10 min lower than the MVR of the outer layers in each case measured according to EN ISO 1133 (190° C., 5 kg weight).

5. The film according to claim 1, wherein the outer layer in each case makes up 8% to 25% and the middle layer makes up 50% to 84% of the entire film thickness.

6. The film according to claim 1, wherein the outer layers comprise 1% to 35% by weight of polylactic acid based on the composition of the outer layers.

7. The film according claim 1, having a haze according to ASTM D1003:2013 of 35% to 60%.

8. The film according to claim 1, having an oxygen permeability measured according to ASTM D3985-05:2010 between 5500 and 18 000 ml/m²/day.

9. The film according to claim 1, having a water vapor permeability measured according to ASTM F1249:2013 of 200 to 1000 g/m²/day.

10. The use of a film according to claim 1 for packaging of salad, fruit and vegetables.

11. A coextrusion process for producing a three-layer polyester film having a layer construction A/B/C or A/B/A, wherein the two outer layers (A) or (A, C) are composed of:
Ai) 55% to 99.99% by weight based on the polyester mixture of the outer layers of a biodegradable aliphatic-aromatic polyester;
Aii) 0.01% to 5% by weight based on the polyester mixture of the outer layers of at least one additive selected from the group consisting of: a wax, a plasticizer, a nucleating agent, antifogging agents, fillers and an antiblocking agent; and
Aiii) 0% to 44.99% by weight based on the polyester mixture of the outer layers of a further biodegradable polymer selected from the group consisting of: polylactic acid (PLA), polycaprolactone (PCL), polyhydroxyalkanoate, polypropylene carbonate (PPC) or polyester produced from aliphatic dicarboxylic acids and an aliphatic dihydroxy compound;
and the middle layer B is composed of:
Bai) 40% to 75% by weight based on the mixture of the middle layer of a biodegradable aliphatic-aromatic polyester;
Baii) 25% to 40% by weight based on the mixture of the middle layer of starch having a plasticizer content of 0% to 5% by weight based on the total weight of the component Baii); and
Baiii) 0% to 20% by weight based on the mixture of the middle layer of a further biodegradable polymer selected from the group consisting of: polylactic acid (PLA), polycaprolactone (PCL), polyhydroxyalkanoate, polypropylene carbonate (PPC) or polyester produced from aliphatic dicarboxylic acids and an aliphatic dihydroxy compound;
or
Bbi) 25% to 70% by weight based on the mixture of the middle layer of a biodegradable aliphatic-aromatic polyester;
Bbii) 30% to 55% by weight based on the mixture of the middle layer of starch having a plasticizer content of 5% to 35% by weight based on the total weight of the component Bbii); and
Bbiii) 0% to 20% by weight based on the mixture of the middle layer of a further biodegradable polymer selected from the group consisting of: polylactic acid (PLA), polycaprolactone (PCL), polyhydroxyalkanoate, polypropylene carbonate (PPC) or polyester produced from aliphatic dicarboxylic acids and an aliphatic dihydroxy compound; and
wherein the MVR of the middle layer measured at a water content of less than 2000 ppm is between 0.5 to 3 cm³/10 min lower than the MVR of the outer layers in each case measured according to EN ISO 1133 (190° C., 5 kg weight).
